(19) United States
(12) Patent Application Publication
(10) Pub. No.: US 2010/0306033 A1
(43) Pub. Date: Dec. 2, 2010

(54) ELECTRICAL POWER METERING AND BILLING NETWORK

(76) Inventors: Dror Oved, Burlington, MA (US); Edward McIntyre, Franklin, MA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/783,930

(22) Filed: May 20, 2010

Related U.S. Application Data
(60) Provisional application No. 61/183,066, filed on Jun. 1, 2009.
(60) Provisional application No. 61/183,070, filed on Jun. 1, 2009.

(51) Int. Cl. G06Q 50/00; G06Q 30/00; G06Q 10/00; G06Q 20/00; G06F 1/26; H04L 1/18; G06F 7/04

(52) U.S. Cl. 705/10; 705/14.1; 705/34; 705/412; 340/5.65; 700/295; 714/749

(57) ABSTRACT

A method and system for facilitating the purchase of electricity between static provider (e.g, an Outlet Owner (OO)) and dynamic/mobile customer (e.g., a Plug Holder (PH)). The system can create open-market, real-time rate and cost determinations based on the conditions of a Charging Instance (CI) and other electricity transfers. In an embodiment, the invention can provide a Transaction Center configured to receive Charging Instance information over communications links. The Transaction Center can include computers and storage devices configured to process Charging Instance data and reconcile accounts of Plug Holders and Outlet Owners. The Transaction Center can be configured to determine the cost of electricity for a particular outlet and a particular plug. Promotional and market data can be used to calculate the cost. Clusters of outlets and groups of Plug Holders can be established. The Transaction Center can perform heuristic analysis of the data associated with a collection of Charging Instances. Users can receive predictive data for their vehicle configuration and current state based on accumulated data. The Transaction Center can communicate with Enabling Devices, Outlets, Connected Devices, and Vehicles.

### CROSS-REFERENCE TO RELATED ACTIONS

This application claims the benefit of U.S. Provisional Application Nos. 61/183,066 and 61/183,070, which were both filed on Jun. 1, 2009 and are incorporated herein by reference.

### BACKGROUND

Electrically powered vehicles are becoming increasingly important to transportation planning. Correspondingly, the accessibility of charging locations is an important facet of incorporating electric vehicles in a transportation system. It is likely that within a few years people will rely on the ability to charge their cars anywhere. There is, however, currently a gap between the rate of electric car adoption and the ability to provide charging stations in all locations. Draining the battery and becoming stranded is a substantial fear of the average electric car owner. Due to the limited range and operating time of the electric car and battery, the car owner or plug holder will likely try to charge their cars during any stop longer than half an hour. Unlike re-filling a petroleum based fueled car, which generally only takes a few minutes, charging an electric car's battery is expected to take a much longer time to complete. In order to accomplish the charging of the car battery, it is expected that an industry of charging stations, akin to the current spread of gas stations, will arise. However, before such stations populate the landscape much like the gas stations do today, electric car owners will need other options for charging their car's battery, including charging in such un-conventional or un-centralized locations such as work locations or office buildings, schools, local stores, shopping malls, and homes of other individuals. The value of these unconventional locations is expected to persist even after a full infrastructure of charging stations is developed.

It is assumed that electric cars will have electric plugs which will be able to plug into the electrical outlets of such unconventional locations and obtain the electric power needed to charge the battery. However, it is not expected that any industry, government or individual will allow such transfer of electric power to the car owner without payment for the electricity used. Accordingly, there is a need for an apparatus which will enable electric car owners to recharge their cars in many un-centralized locations with the ability to conveniently pay for the electricity used to charge the battery.

### SUMMARY

In an aspect, the invention comprises a computer implemented method to facilitate the purchase of electricity between a static provider and a dynamic customer. The computer implemented method can include establishing a communications connection between an enabling device and a transaction center, receiving information about a plug associated with the customer and an outlet associated with the provider, utilizing a computer in the transaction center to calculate a cost of electricity based at least on the received plug and outlet information, and sending the cost of electricity to the enabling device.

Embodiments of the invention may include one or more of the following features. The computer implemented method can include connecting a customer's electrical load to a provider's electrical source, such that the enabling device is configured to monitor electricity flowing from the source to the load, calculating a cost of a charging instance based on the cost of electricity and information associated with the electricity flowing from the source to the load, and displaying the cost of the charging instance on the enabling device. The enabling device can be configured to control and monitor the flow of electricity from the source to the load. The computer implemented method can also include connecting a customer's electrical load to a provider's electrical source, such that the enabling device is configured to at least monitor the flow of electricity from the source to the load, sending charging instance information to the transaction center, storing the charging instance information on at least one data storage device, utilizing at least one computer to calculate a cost associated with the charging instance based at least on the charging instance information and the received plug and outlet information, notifying the customer and the provider of the costs associated with the charging instance, and transferring funds based on the cost of the charging instances between accounts associated with the customer and the provider. Notifying can be implemented via a letter, email message, SMS message, web services message or web portal update. The information about the outlet can be a geographic position. The enabling device can be configured to monitor electricity flowing from the load back to the source.

In an another aspect, an embodiment of the invention provides a system for determining and reconciling costs associated with charging an electric load, including at least one data storage device having an interface for communicating over a computer network, the data storage device including a data structure with a plug ID associated with the electric load, an outlet ID associated with an electrical source, a charging instance ID associated with a single charging instance. The system also can include at least one server computer having an interface for communicating over a computer network, such that the server computer can be programmed to communicate with the data storage device, receive charging instance data comprising a plug ID and an outlet ID, generate a charging instance ID, store the charging instance ID, plug ID and outlet ID in the data storage device, calculate a cost associated with the charging instance data, and transmit the cost associated with the charging instance data over the computer network.

Embodiments of the invention may include one or more of the following features. The server computer can be programmed to receive a request for a charging instance, such that the request includes the plug ID, verify the plug ID against at least one preexisting data table, and send a charging instance approval code based on the verification. The server computer can also be programmed to create a billing statement for a plug holder based on the costs of each charging instance associated with the plug holder, transmit the billing statement to a destination associated with the plug holder, and transferring funds based on the costs associated with the charging instances from an account associated with the plug holder to at least one account associated with at least one Outlet ID. The server computer can also be programmed to create a usage statement for an outlet owner based on the costs of each charging instance associated with the outlet owner, and transmit the usage statement to a destination associated with the outlet owner.

Embodiments of the invention may include one or more of the following features. The data storage device can include a data structure for electricity rate promotions data and the server computer can be programmed to calculate the cost associated with the charging instance based on the electricity rate promotions data. The server computer can be programmed to calculate an expected range of the electric vehicle based on charging instance data, and transmit the expected range over the network. The server computer can be programmed to calculate the expected range of the electric vehicle based on a collection of charging instance data stored on the data storage device.

In another aspect, embodiments of the invention provide an apparatus to enable the purchase of electricity. The apparatus can include a communications module configured to transmit and receive data over a network, an electrical monitoring module configured to measure the electrical current flowing from the outlet to a load, an electrical switch, and a controller including a memory module and a processor. The controller can be programmed to transmit a charging instance request including an Outlet ID and a Plug ID, receive a charging instance approval, control the electrical switch to allow electricity to flow from the outlet to the load based on the charging instance approval, periodically transmit charging instance information including electrical current measurement data, terminate the charging instance, and transmit a charging instance summary including the duration or amount of electricity transferred during the charging instance.

Embodiments of the invention may include one or more of the following features. The charge instance approval can include charging parameters and the controller can be programmed to control the charging instance based on the charging parameters. The controller can also be programmed to detect a communication failure related to the periodically transmitted charging instance information, store the charging instance information in the memory, and subsequently transmit the charging instance information. A retrofit device can be configured to retrofit an existing electrical outlet to control the flow of electricity from the outlet to the electric load during a charging instance to prevent unauthorized electrical flow from existing outlet, the retrofit device can include a securing mechanism configured to restrict the disjoining of the apparatus from the outlet. A RFID reader can be connected to the controller and configured to detect the Plug ID of a plug key located within the operational range of the RFID reader. The communications module, electrical monitor, the controller, the switch, and the RFID reader can be located in separate enclosures.

In accordance with implementations of the invention, one or more of the following capabilities may be provided. A power transfer monitoring apparatus can identify an electricity outlet. A power transfer monitoring apparatus can communicate with a transaction center. Account and charge data can be transferred between the power transfer monitoring apparatus and the transaction center. The transaction center can enable the financial reconciliation between a Plug Holder (PH) of various types of Electric Vehicles (EV) and the electricity Outlet Owner (OO). The transaction center can communicate with financial institutions and/or end user accounts. Electrical power can be transferred between a power distribution network and a battery storage device (such as the batteries in an electric car). The electricity transfer can be in both directions. The transaction center can be specifically programmed to send and receive electronic communications, perform account and component identification (e.g., plugs, outlets, power transfer monitoring apparatus, cellular phones, PDA), electricity monitoring, data logging and mining, data transfer and report generation. Rate notifications and solicitations, and fund transfer activities can be processed.

These and other capabilities of the invention, along with the invention itself, will be more fully understood after a review of the following figures, detailed description, and claims.

### BRIEF DESCRIPTION OF THE FIGURES

FIG. 1 is a block diagram of an electrical power metering and billing network

FIG. 2 is a block diagram of an embodiment of the network including an interlocked power control device.

FIG. 3 is an exemplary flowchart of a specific program configured to run in an enabling device.

FIG. 4 is an exemplary flowchart of a specific program configured to run in a Transaction Center.

FIG. 5 is an exemplary block diagram of possible correlations between Plug Holders, Charging Instances, and Outlet Owners.

FIG. 6 is a block diagram of a marketing promotions and rate determination process.

FIG. 7 is an exemplary system diagram of a device displaying a computed driving range based on battery condition.

FIG. 8 is an exemplary block diagram of an embodiment of an electrical power metering and billing network including an outlet configured to communicate with a transaction center.

FIG. 9 is a perspective block diagram of outlet control retrofit device.

FIG. 10 is an exemplary block diagram of an embodiment of an electrical power metering and billing network including an external device configured to communicate with a transaction center.

FIG. 11 is an exemplary block diagram of an embodiment of an electrical power metering and billing network utilizing a plug key and an on-board communication system to communicate with a transaction center.

### DETAILED DESCRIPTION OF PREFERRED EMBODIMENTS

Embodiments of the invention provide techniques for facilitating the purchase of electricity between static provider (e.g, and Outlet Owner (OO)) and dynamic/mobile customer (e.g., a Plug Holder (PH)). The system can create open-market, real-time rate and cost determinations based on the unique conditions of a Charging Instance (CI) and electricity transfer case. For example, an electrical power and billing network can include a Transaction Center configured to receive Charging Instance information over a communications link. Enabling Devices can send and receive data associated with a Charging Instance. The Transaction Center can approve or deny a request for a Charging Instance. The Transaction Center can include computers and storage devices configured to reconcile accounts of Plug Holders and Outlet owners. Billing information can be sent to Plug Holders based on their usage. Outlet owners can be credited for electricity used by Plug Holders. Plug Holders can establish accounts to pay for their usage. The Transaction Center can be configured to determine the cost of electricity for a particular outlet and a particular plug. Promotional and market data can be used to calculate the cost of a Charging Instance. Clusters of outlets and groups of Plug Holders can be established. The Transaction Center can perform heuristic analysis of the data associated with a collection of Charging Instances. Users can receive predictive data for their vehicle configuration and current state based on accumulated data. The Transaction Center can communicate with Enabling Devices, Outlets, Connected Devices and Vehicles. Existing outlets can be retrofitted to participate in the network. This electrical power and billing network is exemplary, however, and not limiting of the invention as other implementations in accordance with the disclosure are possible.

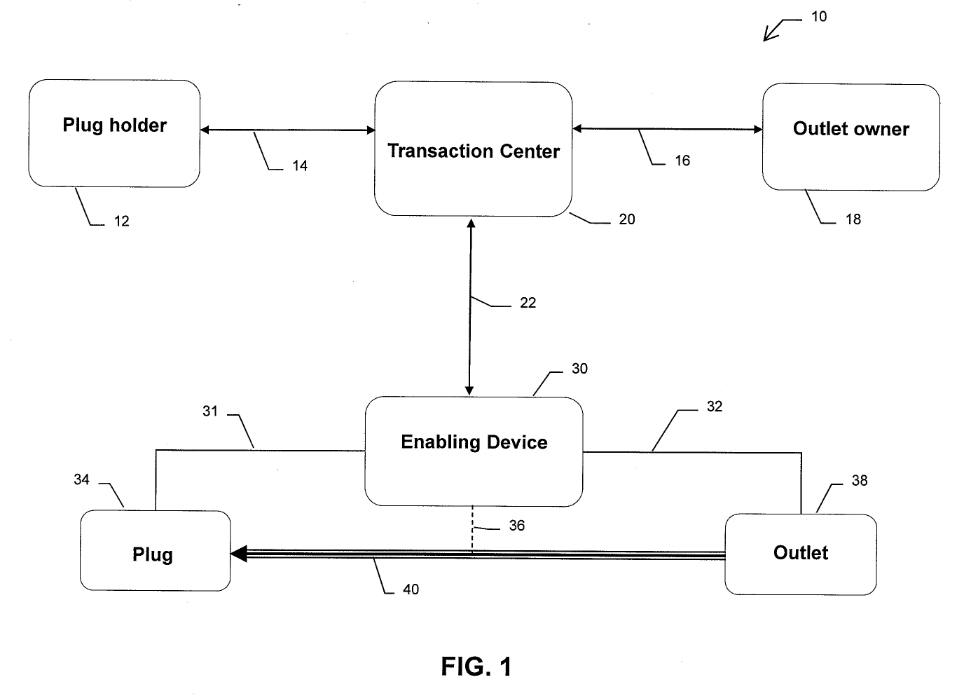

Referring to FIG. 1, a block diagram of an electrical power metering and billing network 10 are shown. The network 10 includes an entity identified as a Plug Holder (PH) 12, and entity identified as an Outlet Owner (OO) 18, a Transaction Center 20, a communications path 14 between the PH 12 and the Transaction Center 20, a communications path 16 between the OO 18 and the Transaction Center 20, an Enabling Device 30, a communications path 22 between the Enabling Device 30 and the Transaction Center 20, a plug 34 configured to receive power from an outlet 38 via a power conduit 40, wherein the Enabling Device 36 is operably coupled to the power conduit 40 and configured to monitor the electricity flowing through the conduit. In an embodiment, the Enabling Device 30 can be operably connected to the plug 34 and/or the outlet 38 via communication paths 31, 32. For simplicity, the PH 12 and the OO 18 as represented in FIG. 1 can represent persons or their associated agents (i.e., bank accounts, credit card accounts, or other financial entities). The communication paths 14, 16 to and from the TC 20 can be data representing fund transfer between the entities, as well as data regarding account status such as charging rates, billing information, charging data reports, and promotional content (e.g., notifying a PH 12 about the prices a given OO 18 is offering), and request for bids.

In an embodiment, the Enabling Device 30 can be connected between the plug 34 (e.g., a plug on an electric car, a plug on a laptop computer or other electronic device) and the electricity outlet 38. The device 30 can be configured to monitor, log and display the electricity usage and other attributes of a charging instance. For example, the network 10 can be configured to provide financial reconciliation of electricity usage between an electric car owner or user (i.e. a plug 34) and a provider of the electricity (i.e. an outlet 38). The Enabling Device 30 can be configured to monitor the electrical usage or power transferred during charging of the electric car from the power provider 38. In an embodiment the Enabling Device 30 can be configured to also monitor the electrical power discharging from the electric car 34 back to the provider or the utility 38. The Enabling Device 30 can be configured to communicate with the Transaction Center 20 via the communication path 22 that can be via the plug or the outlet or other external or internal communication devices. The communication path 22 can be, for example, existing cellular networks, local WiFi Hot Spots, and/or the Internet via a combination of wireless and tethered applications (e.g., synchronization via a personal computer or PDA that is connected to the Internet (not shown)). The Transaction Center 20 can include a computer systems configured to send and receive Charge Instance data, calculate the usage cost for a Charging Instance, and a data storage unit (e.g., database application) to log information relative to the charging or discharging functions.

The Enabling Device 30 can include a location identification unit such as a GPS system to accurately determine the location of the plug 34 and the outlet 38. The use of a GPS system is exemplary only and not a limitation as manual location identification, cellular based location identification, or selection of a predefined location list can be used to identify the location of the plug 34 and the outlet 38. The Enabling Device 30 and/or Transaction Center 20 can include a software application and database to correlate the Outlet 38 with an owner based on location information. For example, this location database can persist in the memory of the Transaction Center 20 and can be accessed by the Enabling Device 30 (i.e., as a location based service). In an embodiment, the location database can persist on the Enabling Device 30. The Enabling Device 30 can include a communication path 32 to communicate with the outlet 38. For example, the Enabling Device 30 can be configured to activate an RFID apparatus in the outlet 38. In an embodiment, the communication link 32 can be data signals transmitted through the power conduit 40. The Enabling Device 30 can be configured to communicate with the plug 34 through communication link 31. For example, the plug 34 can be in an electric vehicle configured to communicate via Bluetooth or other wireless technology. While embodiments of the invention can be applied to electric vehicles, the invention is not so limited. The Enabling Device 30 can used for consumer sized electrical devices such as laptop computers and personal media devices (e.g., iPad®, iPhone®) and other appliances that require electrical power.

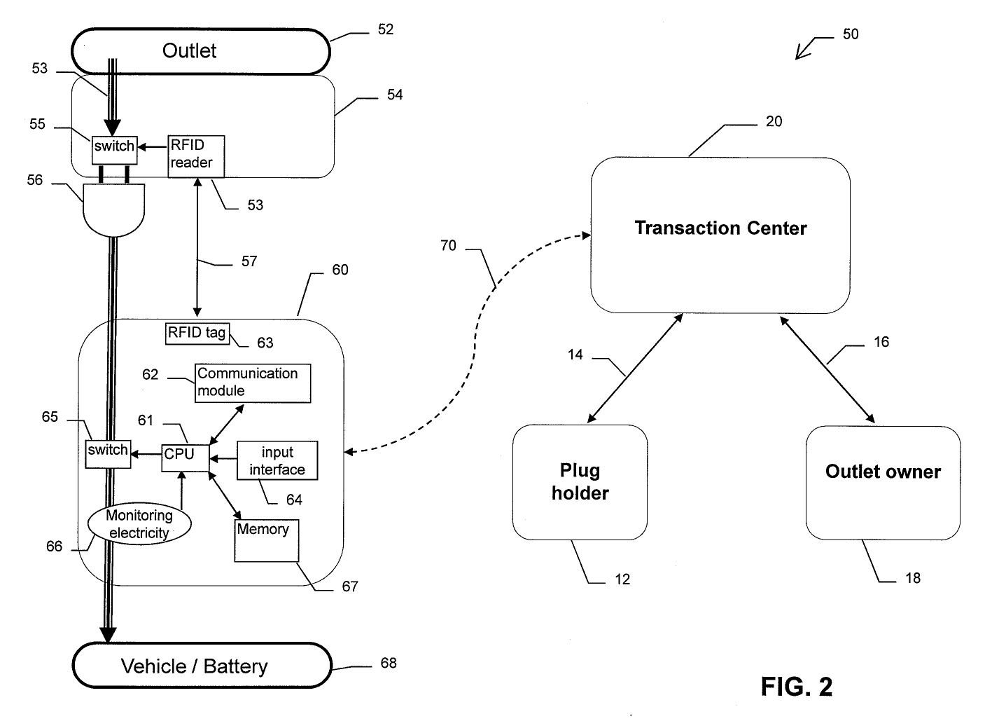

Referring to FIG. 2, with further reference to FIG. 1, an embodiment of the network 50 including an interlocked power control device (PCD) 54 is shown. The network 50 includes an outlet 52, an interlocked power control device (PCD) 54 operably coupled to the outlet 52, a plug and power conduit 56, an external device 60 (i.e., an InCharge System (ICS) device), and an electric vehicle 68 operably coupled to the ICS 60 and the PCD 54. In an embodiment, the outlet 52 is an existing UL configuration (i.e. 120/220/240/440/480 volts), and the PCD 54 can be rigidly affixed to the outlet 52 (i.e. fastened, welded, encapsulated with). In an embodiment, the outlet 52 and the PCD 54 can be a single assembly. The PCD 54 can include a detection system such as an RFID reader 53, and an electric switch 55 configured to enable or disable current flow from the outlet power output 51 to the plug 56. In operation, the PCD 54 is configured to detect an RFID tag via a near field transmission 57, and then allow the switch 55 to close (i.e., allow current flow) if a valid ID is detected. In an embodiment, the PCD 54 can include a visible outlet ID to correlate the outlet 52 with an outlet owner 18 and appropriate rate information stored in the Transaction Center 20.

The ICS 60 can include a processor 61, a communications module 62, a RFID tag 63 (e.g., in the device, plug, or cable), and input interface 64, an electrical switch 65, an electrical monitor 66, and a memory 67. The processor 61 can be specifically programmed to enable communication with the Transaction Center 20 over a wireless communication network 70. In general, the ICS 60 can enable monitoring of the power flow 40, communication with the Transaction Center 20, and communication with the outlet 38. The ICS 60 can be configured to provide input/output to/from a local user, and the memory 67 can be configured to store information about charging instances. The CPU 61 can be programmed to control the operational elements of the ICS 60. In operation, a user can enter the outlet ID into the ICS 60 via the input interface 64. The ICS 60 can request authorization for a charging instance from the Transaction Center (TC) 20 by sending account information or other identification stored in the memory 67. The TC 20 can be configured to receive the information from the ICS 60 and return authorization data such as maximum KWH, authorized charge times, and authorized charge duration. Upon receiving the authorization data, the switch 65 can be set to a close position to allow current flow from the outlet 52 to the vehicle 68. The electrical monitor 66 is operably coupled to the processor 61 and is configured to detect parameters of the charge (e.g., voltage, amperage, phase). The ICS 60 can be configured to communicate the parameters associated with the charging instance (e.g. location, ID, date, time, duration, KWH used) to the TC 20, and receive confirmation and cost data from the TC 20.

In an embodiment, the Transaction Center 20 includes one or more computer servers. These computer servers (i.e. systems) represent any single or multiprocessor computer. In an example, the TC 20 functionality is implemented in a multiplatform (platform independent) programming language such as Java, programming language or structured query language (SQL), hypertext markup language (HTML), practical extraction report language (PERL), flash programming language, common gateway interface/structured query language (GCI/SQL), or the like. In an embodiment, high-level programming languages (e.g., C++, C#) and applications written for the Microsoft Windows or Sun OS environments can be used. In an embodiment, the computer systems in the TC 20 can be configured to execute instructions associated with a relational database system such as, but not limited to, Oracle® or Microsoft SQL Server®. The database system can include one or more data structures such as data tables and data queries. The computer systems can include one or more processors configured to execute software implementing the routines described herein. The computers can be configured interpret instructions via a computer-readable medium such as floppy disks, conventional hard disks, CD-ROMS, DVDs, Flash ROMS, nonvolatile ROM, and RAM.

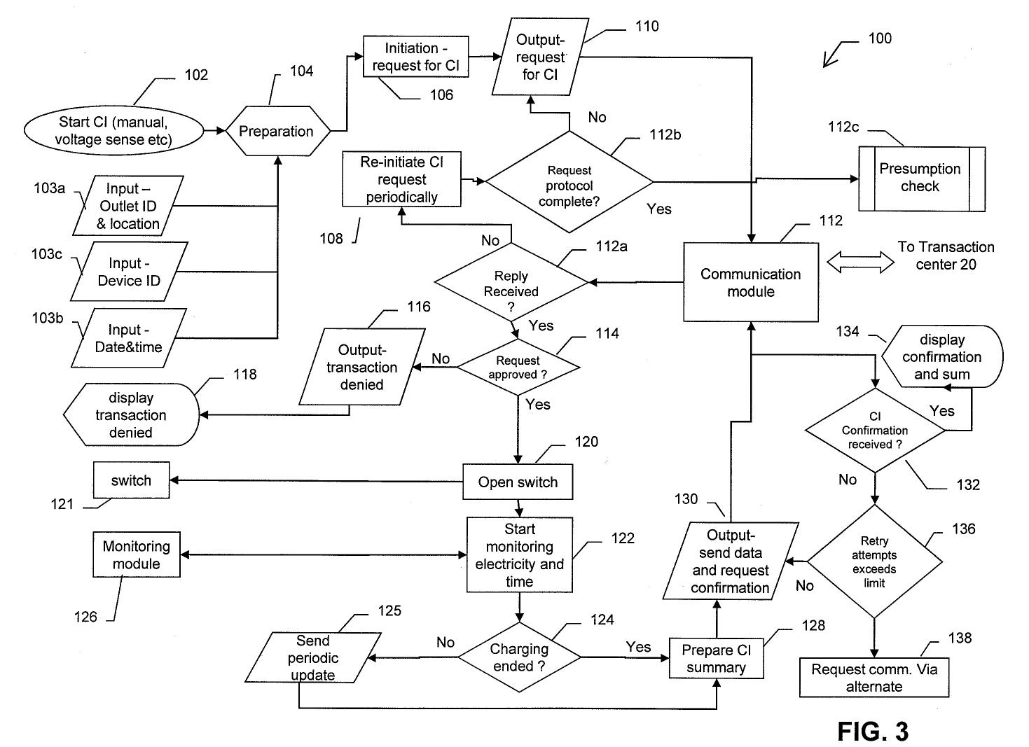

In operation, referring to FIG. 3, with further reference to FIG. 2, the processor 61 in the ICS 60 can be specifically programmed to perform the illustrated process 100. The process 100, however, is exemplary only and not limiting. The process 100 may be altered, e.g., by having stages added, removed, or rearranged.

At stage 102, a charging instance (CI) can be initiated. The initiation can be a manual or automatic process based on one or more system events (e.g. a voltage sense event, an RFID sense event, or a remote initiation event).

At stage 104, the CPU 61 collects the information required to initiate the CI (i.e., an outlet ID and location information 103a, date and time information 103b, ICS ID information 103c). For example, the outlet ID is an alphanumeric variable that can be printed on the outlet itself and manually entered into the ICS 60. In an embodiment, the user can select an outlet ID from a menu option on the ICS 60. The menu list can be based on location information received by the ICS 60 (i.e. GPS data, cellular location), and previous use information (i.e. the outlet has been used in the past). The outlet ID information can be received through an RFID system 57. The outlet location information can be based on latitude and longitude coordinates, or other universal or regional coordinate systems (e.g., UTM, city address).

At stage 106, once the CPU 61 collects the required information, the CPU will prepare data to command a CI request through the communication module 62 and communication path 70 for a charging instance. In an embodiment, the ICS 60 may not be in communication with the TC 20 and therefore the CPU 61 can be configured to store the CI request data in the memory 67. At stage 108, the CPU 61 can be configured to reinitiate communication with the TC 20 on a periodic basis to transfer the CI request data. As will be described, a charging instance can be initiated without communications between the ICS 60 and the TC 20. In an embodiment, the ICS 60 can be configured to store the CI data until such a time as when the data can be transferred to the TC 20 (e.g. when returning to cell phone coverage area, entering a WiFi hotspot, or a tethered application to the Internet).

At stage 110, when communication is established between the ICS 60 and the TC 20, a request is sent to the TC 20 via the communication module 62. At stage 112, the communication module 62 can establish a communication link 70 with the TC 20, and can be configured to transmit the CI request data. The communication module 62 can also be configured to receive CI data (i.e. approval/denial) from the TC 20.

At stage 112a. the system waits a predetermined time for a response from the TC 20 regarding the CI request initiated in stage 110. At stage 108, the CPU 61 can be configured to reinitiate communication with the TC 20 on a periodic basis to transfer the CI request data. At stage 112b, the system evaluates the status of progress through a protocol of repeated attempts to contact the TC 20. If this procedure has been completed, and attempts to communicate with the TC 20 have failed, then in Stage 112c a presumption check process is initiated. In an embodiment, if a ‘presumption of permission’ status is true, the device grants approval to proceed with the CI at stage 120. The ‘presumption of permission’ status can subsequently be set to false to minimize exposure to fraud. For example, if the ‘presumption of permission’ status to false, then the system denies permission to charge (at stage 116).

At stage 114, the CI data received from the TC 20 is evaluated. If the CI request is denied 116, at stage 118 the user can be notified via the input interface 64 and the switch 65 can be opened (i.e., does not allow current flow). In an embodiment, the RFID communication path 57 can be used to open or close the switch 55. In an embodiment, the TC 20 can be configured to communicate with the PCD 54 and can send instructions to open the switch 55 if the CI request is denied. In general, a CI request can be denied based on validation information and can be used to minimize fraud, verify account funding, and/or to comport with an outlet owners desire not to provide electricity during certain times. In an example, an outlet owner may own a garage with dozens of outlets and can configured his account such that only 20 vehicles, for example, can be charged during a single time period. In an embodiment, the CI approval received from the TC 20 can include pricing and other promotional information based on the ID of the outlet 38, the ID of plug 34, the ID of the plug holder 12, the ID of the Outlet Owner 18, and various combinations thereof. In an embodiment, the pricing and promotion information can be transmitted from the TC 20 or outlet independent from the CI approval process. For example, pricing and promotion information can be sent to a user in an effort to assist the user in finding a suitable charging location.

If the CI request is approved at stage 114, the CPU 61 can be programmed to send a switch command 121 to close the switch 65 and allow power to flow. This also begins a charge flow and monitoring loop, depicted in stages 122, 124 and 126. In an embodiment, the approval evaluated at stage 114 can be conditional. For example, the CI approval can specify one or each of the following: a time of day in which charging is allowed (e.g., start time(s) and stop time(s), the amount of charge (e.g. in kilowatt hours), and/or the duration of the charge (e.g. in minutes). Other constrains on the CI can also be used.

At stage 126, the monitoring module 66 can send periodic signals to the CPU 61 to indicate the status of the charging instance. In an embodiment, the charging parameters (e.g., voltage, current) are controlled by the charging control system installed on the vehicle, and the ICS 60 is configured to detect when the charging current drops to a specified minimum. For example, the electric vehicle may include a charging system which allows for a high current charging event (e.g., 10 amps, 15 amps, 20 amps) and a much lower trickle charge (e.g. less than 2 amps) when the battery charge level is full, or near full. At stage 125, periodic updates of the charging status can be sent to the TC 20. When a specified minimum charge or other IC parameter is reached, the ICS 60 can consider the charge complete at stage 124 and open the switch 65. In an embodiment, the vehicle can include a control signal (e.g., via wire such as the SAE1772 standard, or via wireless transmission) and the ICS 60 can be configured to receive this control signal. The control signal can indicate the status of the vehicles batteries during a charge, for example, and can provide input to the ICS 60 as to when a charge is complete, or near complete. In an embodiment, the ICS 60 includes a “stop charge” command button on the input interface 64 (e.g., a physical button, a GUI on a touch screen device), and the user can stop a charging instance by pressing the button. The ICS 60 can also include safety features (e.g. overload sensors, high temperature sensors, high current trips, ground fault indicators, and other UL standards) configured to end the charging instance.

In an embodiment, since a CI is open-ended and without a fixed duration, the ICS 60 device regularly monitors the charging status at stage 122, and if the charging instance has ended (e.g., at stage 124) a summary is prepared at stage 128. If the charging instance has not ended, then a periodic update is sent at stage 125 and 128. These periodic reports (e.g. once every 60 min or some other time basis) indicate continued successful charging operations. An interim confirmation report is received by the device in stage 132. The device can report via several communication channels such as through the web if the communication module fails. When the CI has ended, the ICS 60 device can be programmed to continue to send the final output data (e.g., stages 130, 132, and 136) until it receives a confirmation at stage 134. If the device fails to receive at stage 136 either an update or a completion report after a predetermined number of attempts, the device requests an alternate means of communication at stage 138.

In an embodiment, the TC 20 can send a control signal to the ICS 60 during a charging instance. This can provide the TC 20 with a macro level mechanism to control the amount of power being consumed in a given geographic area. For example, during periods of high demand, such as in the summer when air conditioners are running, the TC 20 can receive macro level power consumption information from a regional service provider and can be configured to interrupt one or more charging instances in an effort to minimize the load on a regional grid. As will be discussed, the TC 20 can also be configured to notify a user via a communication medium (i.e. e-mail, automated phone message, SMS message) that the charging of their vehicle has been interrupted, changed and completed.

The sophistication of the data received from the monitoring system 66 can vary based on the needs of the market (i.e., the price point of embodiment of the ICS 60 can change based on the technology incorporated in the device). That is, the CPU 61 can receive and store charging data at different frequencies and with different levels of resolution. In an embodiment, the CPU 61 can be programmed to analyze the collection of charging data recorded during a charging instance and provide the user with information regarding the health of the vehicle's battery system. For example, the charging profile of a battery system can change through polarization, or other interstitial processes, and thus can be determinative of the overall health of the battery system. Such health, or other battery performance indicia, can be calculated and displayed locally by the ICS 60, or can be calculated on the TC 20 and provided to the ICS 60 via the communications link 70 (e.g., rich and thin client configurations). In an embodiment, this information can be sent to the TC 20 and made available via a web page or email. As will be discussed, the CI data transmitted to the TC 20 can analyzed individually or in combination with CI data received from multiple users based on vehicle make and model data, charge location data, charging frequency, and/or other information available to the TC 20.

At stage 128, the CI data is collated and sent to the TC 20 via the communications module 62. The CI data can include information such as the amount of power transferred, the amount of time elapsed, and well as the data sent in the original request (e.g., IDs of the Outlet and ICS, time and date). The CI data can also include information regarding interruptions, or other failures, during the charge instance. In an embodiment, the data representing the charging profile of the charging instance (i.e., discrete data points, vector representations) can be included in the CI summary.

At stage 130, the CI summary can be transmitted to the TC 20. In an embodiment, the data transmitted and received between the ICS 60 and TC 20 can be encrypted. The transmission path 70 can include wireless transmissions via a cellular telephone network, wireless transmission via a WiFi connection to the Internet, a tethered application connected to the Internet via a computer or other data processing device (e.g., PDA, BlueTooth, and other data communication systems installed on board the vehicle).

At stage 132, an acknowledgement from the TC 20 can be received and detected. In an embodiment, the CI confirmation is received shortly after (i.e., less than one minute) the charging is complete. As previously described, however, the CI data need not be transmitted to the TC 20 immediately upon the conclusion of the CI. The CI confirmation can be sent at a later time based on available communications networks. In general, the CI confirmation includes the charges the user will incur for the charging instance. As will be described, the TC 20 can calculate the charges based on one or more of the following: the amount of power consumed, the time of the charge, the location of the CI, the ID of the ICS, the outlet ID, previously stored promotions, and other variables associated with a particular CI.

At stage 134, the cost associated with the CI is displayed to the user via the input device 64. These costs can include, for example, the price per kilowatt hour including promotional discounts, if any. In an embodiment, the user can utilize the ICS 60 to verify their account status in the TC 20. For example, the user can view their account balance, or compare the costs associated with the current CI with previous CI's. Dissemination of account status information can also be made available via other methods such as email, SMS, PDA, smart phone, and web access as known in the art.

In operation, an error may occur during the request for a CI (e.g., stage 112a). If the ICS 60 does not receive the request for permission to start a CI the ICS 60 can re-sends the request and wait for an answer, repeating the cycle a set number of times. If no response is received from the TC 20, the ICS 60 can consult a status setting held in non-volatile memory. This status setting relates to the ‘presumption of permission’ to proceed even if no approval is received from the TC 20, as previously described. In general, the initiation of the original request requires the identification of the plug holder, so that accurate billing information is available.

If the protocol of repeated attempts to contact the TC 20 fails, and if the ‘presumption of permission’ status is true, the ICS 60 can grant approval to proceed with the CI and set the value of the ‘presumption of permission’ status to false (e.g., after a predetermined number of such unusual approvals). This action can help prevent abuse such as repeated instances of charging without TC 20 approval.

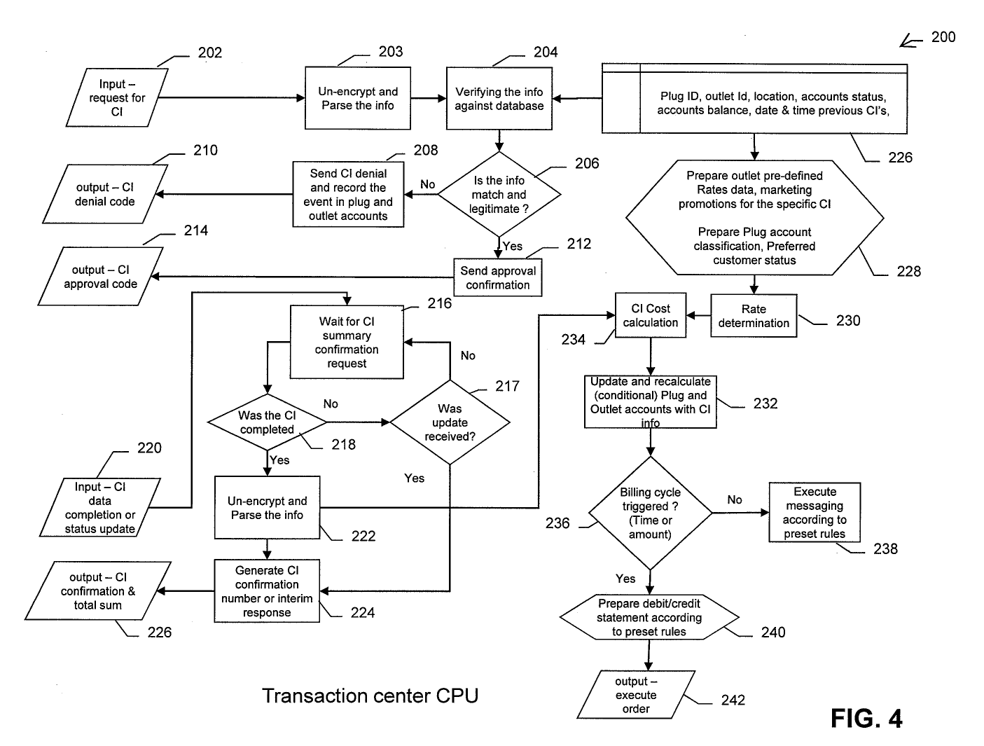

In operation, referring to FIG. 4, with further reference to FIGS. 1-3, the computers in the TC 20 can be specifically programmed to perform the illustrated process 200. The process 200, however, is exemplary only and not limiting. The process 200 may be altered, e.g., by having stages added, removed, or rearranged.

At stage 202, a request for a CI can be received and a charging instance ID can be generated. In an embodiment, the CI request can include, for example, an outlet ID and location information 103a, date and time information 103b, ICS ID information 103c. In general, the data associated with the CI can be transmitted from the ICS 60 or PDC 54 in an encrypted format. At stage 203, the CI request data can be decrypted and parsed into appropriate data fields. At stage 204, the CI request data is verified against database tables in the TC 20. In an embodiment, these data tables can be accessed at stage 226, and can include information such as plug IDs, outlet IDs, locations, account information, and historical data regarding previous CIs (e.g., dates, times, charges incurred, and promotional benefits), general plug account classifications (e.g, student, senior) or in specific relation to an outlet (e.g, preferred customer, employee benefit, point system, VIP). For example, the TC 20 can include a charging instance table which includes a Plug ID, Outlet ID and Charging Instance ID and other data associated with a CI. Additional data associated with the plug (e.g., vehicle, user), and the outlet (e.g., owner, promotions, charging restrictions) can be stored in additional tables and include indexes that relate to the charging instance table. In an embodiment, the data tables in the TC 20 can include information regarding outlet clusters such as in a parking garage, for example, where multiple outlets can be physically available to users, but the corresponding power distribution infrastructure can limit the amount of power available for charging at any given time. The data tables within the TC 20 can be configured with time-sharing data to ensure a given outlet cluster does not exceed established power distribution limits.

At stage 206, a decision can be made as to whether the incoming data associated with the CI request is legitimate in view of the data tables in the TC 20. At stage 208, if the CI request data is not legitimate then the TC can send the ICS 60 a denial code 210 and record the denied event in the appropriate data tables (e.g. plug ID, outlet ID). If the CI data is legitimate, then an approval confirmation is generated at stage 212 and can be transmitted to the ICS 60 at stage 214.

Once a CI request is approved, at stage 216 the TC 20 can open a charging instance and await a response from the ICS 60 device at stage 218. At stage 220, the CI summary or update (e.g., complete or partial) can be sent to the TC 20 from the ICS 60. Once the data from the CI summary arrives, it can be parsed and stored in the appropriate database at stage 222. For example, if the CI was completed, then the CI information is stored in a database. If the communication is an update (e.g., at stage 217) the TC 20 continues to monitor input from the device (e.g, at stage 216) and created a conditional accounting of the CI at stage 224. At stage 226, the CI confirmation and cost information can be transmitted to the ICS.

At stage 234, the TC 20 can compute the cost information associated with the CI. In an embodiment, the costs of a CI can be related to the outlet location and/or outlet ID. For example, the cost of a particular CI can be based on the time at a particular outlet, and/or the number of kilo-watt hours used. This cost information can be predefined for each outlet ID and/or outlet location and stored in the data tables. For example, an outlet owner 18 can enter the contractual rate, or similar rate rules, they pay for power into the data tables. The outlet owner can similarly enter the amounts that they want to charge for power at their outlets. As used herein, the terms cost and price are synonymous in that they represent a monetary value associated with the transfer of electrical power. Additional data fields can be used to determine the costs associated for a charge. In an example, the an outlet owner can provide a charging instance as a promotional tool wherein a user receives two hours of charging for free. In an example, the costs can be related to a combination of the outlet ID and the plug ID such that a particular user (i.e., VIP customer, monthly subscriber, national plan member) receives a personalized rate for using a particular outlet. In an example, the rate charged to a user for a CI can be based on the time of day of the CI. These examples are not limitations as other combinations of outlet, plug, user, location, temporal, promotional, and market data can be used to determine CI rates. At stage 228, rate information can be retrieved from the data tables in the TC 20.

At stage 230, a rate for a CI can be determined. In an example, a user can park at a well known coffee house chain and can receive two hours of free charging (i.e., a promotional rate). After the first two hours, the user can be charged a fixed rate per hour of charging (e.g., $3 per hour). In another example, a commuter can park in the same downtown parking lot each day. The parking lot owner can provide an outlet and charge the commuter a lower rate (i.e., $1 an hour) because the commuter is a regular, reoccurring, customer. In another example, an outlet owner can charge a standard rate per kilo-watt hour consumed. This standard rate can be established by the regional power providers (i.e., the utility companies). At stage 234, the determined rate can be applied to the data in the CI summary to calculate a cost for the CI

In an embodiment, the TC 20 can receive dynamic pricing and consumption information from the regional power providers. This information can be used for load balancing on a regional level.

Once the cost for an instance is determined at stage 234, the accounts associated with the Plug holder and the Outlet owner can be updated with the costs associated with the CI in a billing cycle 232. For example, an account associated with an outlet owner 18 can be credited with the costs, and an account associated with the Plug holder can be debited. The billing cycle 236 can be based on a temporal schedule (e.g., weekly, monthly, quarterly), and/or based on a balance amount. A debit and/or credit statement can be generated at stage 240. In an embodiment, in addition to the costs associated with the charging instances, the statements can include statistics on the market price of electricity (e.g., regional, seasonal, contractual, providing utilities). For example, a statement provided to an outlet owner 18 could include an analysis of the difference in price, if any, between the costs the outlet owner incurred for providing power to plug holders (i.e., the costs the outlet holder must pay to a utility company), and the amount received from the plug holders.

At stage 242 the information in the billing statement can be delivered to an outlet owner, plug holder, and/or their respective financial accounts. In an embodiment, the billing statement information can be made available on the Internet and available for viewing with a browser via a personal computer, PDA, smart phone, or other terminal device.

In operation, a communication failure may occur before a CI ends at stage 124 (FIG. 3) and hence is not communicated to the TC 20 (i.e., stage 218). In general, such errors relate to the failure of the TC 20 to receive the final data summary after a CI. Since a CI can be open-ended and without a fixed duration (i.e, the CI could last for 60 minutes at a shopping center, or 3 days in an airport parking lot), the ICS 60 can send regular status updates to the TC 20. At stage 217, the TC 20 can be configured to forward incomplete CI updates to a cost calculator (e.g., stage 232). In an embodiment, these periodic reports (e.g. once every 60 min) can indicate continued successful charging operations, which the TC 20 receives and logs. The TC 20 can also reply with an acknowledgement to the ICS 60. The ICS 60 can be programmed to continue to send the final output data (e.g., stages 130 and 132) until it receives a confirmation (e.g., stage 134). If the TC 20 fails to receive either an update or a completion report on schedule, it can process a preliminary transaction summary and wait for the ICS 60 to report. At stage 136, the number of retry attempts can be counted. If the count of retry attempts is exceeded, at stage 138 the ICS 60 can report via secondary communication channels (e.g., WiFi, Broadband, tethered internet) if the primary communication module fails to connect to the TC 20.

A similar sequence can occur at stages 216, 218 and 220. The TC 20 can document the periodic reports from the ICS 60. In stage 216, the TC can create preliminary reports and await the final update from the device.

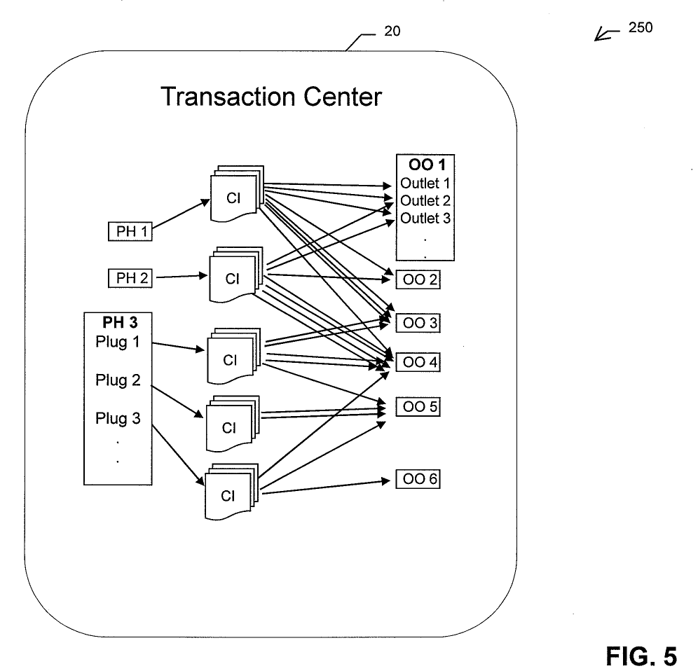

Referring to FIG. 5, a block diagram 250 of possible correlations between Plug Holders, Charging Instances, and Outlet Owners is shown. The data tables in the TC 20 can be configured to create relationships between multiple Plug Holders and Outlet Owners. For example, PH1 and PH2 can represent single accounts, wherein each account is associated with one enabling device 30. PH1 and PH2 can interact with one or more outlets, and the transaction center 20 can allow or deny charging instances based on programmed rules. In an embodiment, PH 3 is a plug holder account and represents a single account with more than one enabling devices 30 (i.e., Plug 1, Plug 2, Plug 3). For example, PH 3 can be a multi-car family, a corporate fleet of vehicles, or a government entity with multiple vehicles. Such an arrangement could be valuable when a user must plug his government vehicle into their personal outlet (OO 6) for charging. The costs associated with the charging instance could be credited to the user, and debited to the to government account (i.e., PH 3). Similarly, outlet accounts can be related in the data tables. For example, a parking garage owner (OO 1) can have multiple charging spots and/or multiple parking lots (e.g, Outlet 1, Outlet 2, Outlet 3). These relations are exemplary only and not a limitation as other outlet and/or plug groupings and relationships can exist. In an embodiment, each plug and outlet can have unique IDs to facilitate the formation of such groupings.

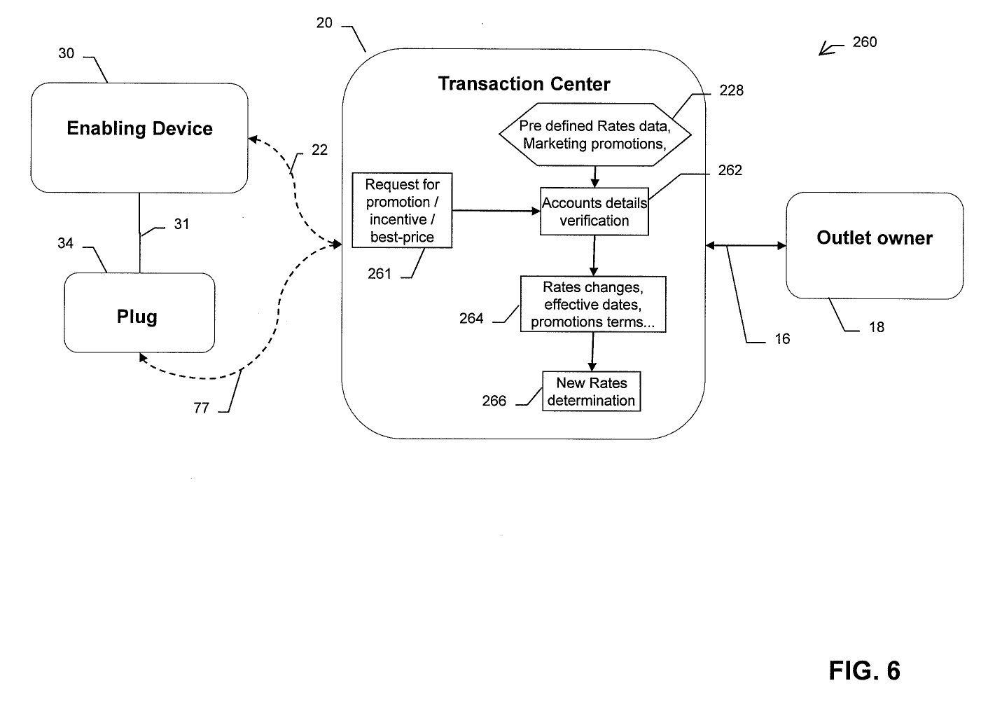

Referring to FIG. 6, a block diagram of a marketing promotions process 260 is shown. The process includes a TC 20, an outlet owner 18, an enabling device 30, and a plug 34. The plug 34 can be configured to communicate with the TC 20 via a communication path 77. In an embodiment, the enabling device 30 can be configured to communicate with the TC 20 via a direct communications path 22, or indirectly through the plug 34 (e.g, via a link 31 and the communications path 77). The TC 20 can be configured to receive promotional data from an outlet owner 18 via a communications path 16. For example, the outlet owner 18 can enter promotional data via a web service or other data portal.

In operation, when a user plugs into an outlet, the enabling device 30 can be configured to display a promotional message. For example, a store can offer to provide free charging during certain times, for a certain length of time, and/or upon a minimum purchase amount. Such promotions can also be presented via smart phone, PDA, web and other connected devices as known in the art. In an embodiment, at stage 228 the TC 20 can calculate a preliminary rate as described above. At stage 262, the account details associated with the plug 34 and the outlet owner 18 can be verified. The promotional terms can be applied to the preliminary rate at stage 264. In the “minimum purchase” example, a representative of the outlet owner can enter a “minimum purchase verification code” into the TC 20 when the plug holder makes the minimum purchase. As examples, and not limitations, the minimum purchase verification code can be automatically generated by the outlet owner's cash register system, by a web service associated with the outlet owner's credit card processing service, or manually entered via terminal by the check out person. The new rate can be calculated at stage 266 and applied to the charging instances as described above. In an embodiment, a rate can be based on a rebate method in which a code is given at the cash register to the user, who then later enters this code on their TC 20 account page. The TC 20 will verify that the code matches the outlet code, location and date of the CI, and then apply the appropriate rate.

In an embodiment, promotional information can be provided to an enabling device 30 upon request. For example, a stage 261 the TC 20 can receive a request from an enabling device 30 to display the best price for charging in proximity to the enabling device 30. The locations and outlet owners can be displayed on the enabling device 30, or other connected device, in ascending order base on price or distance.

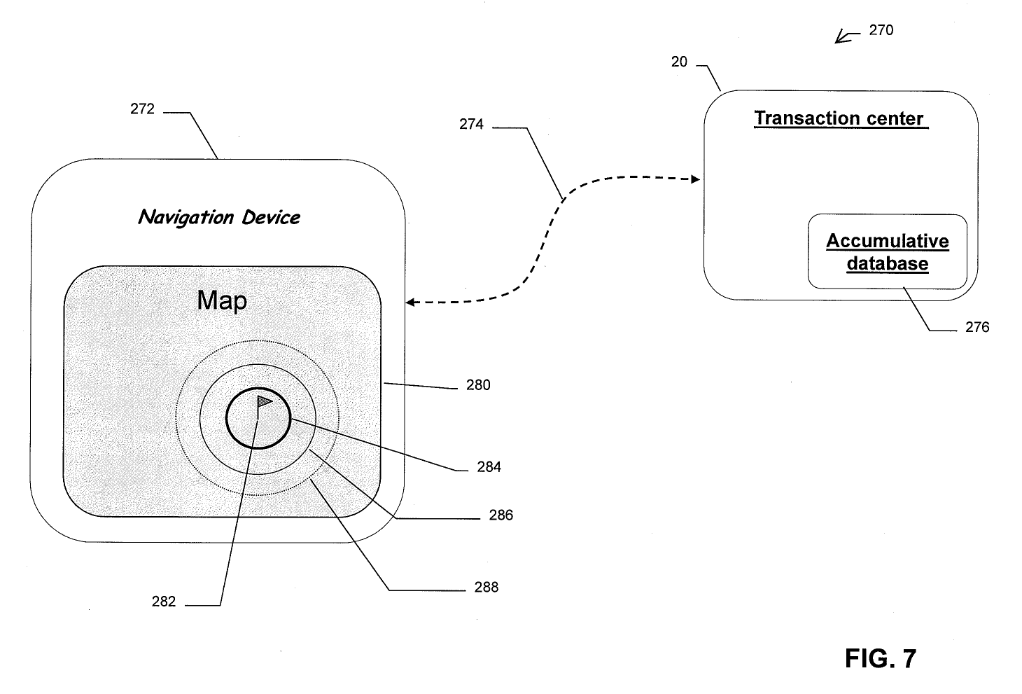

Referring to FIG. 7, with further reference to FIGS. 1-6, an exemplary system diagram of a device displaying a computed driving range based on battery condition 270 is shown. The system includes a transaction center 20, a display device 272, and a communications network 274. The display device 272 includes a display area 280. In an embodiment the display device 272 can be an ICS 60, a PDA, a smart phone, a personal navigation device, or a laptop computer. The communications link 274 can include wireless cellular networks (e.g. 2G, 3G, 4G networks) and/or FM broadcasts such as used by RDS systems. The transaction center 20 can include an accumulative database 276. In that the charging and billing network 10 can include multitudes of users, the transaction center can collect information about a variety of different vehicles and battery configurations. For example, the data fields in the accumulative database 276 can include the vehicle make, model, year, battery model, battery technology, battery charge state, battery age, and time since last charge. Additional data fields in the cumulative database 276 can include regional and environmental factors such as the location of charging instances and local temperature. The TC 20 can include algorithms for mining the cumulative database 276 and determining correlations within these variables to help predict battery performance. For example, battery performance for a given vehicle model and year can be affected by the age of the battery, as well as the geographic region in which the vehicle is operated. The battery performance information can be used to estimate a vehicles range.

In an embodiment, the display device 272 can be configured to display a map in the display area 280. As an example, and not a limitation, the current location of a vehicle can be indicated by an icon 282 and the expected range in which the vehicle can travel based on the current status of the battery can be displayed as a range ring 284. Additional range rings can be displayed based on projected charging times. For example, a medium range ring 286 can be displayed to indicate the range of the vehicle after X hours of charging, and a longer range ring 288 can be displayed to indicate the range of the vehicle after Y hours of charging (wherein Y>X). The predictive ranges need not be range rings and can be based on route information and other location-based services as known in the art. For example, the predicted range of the vehicle could be displayed as a highlight, or endpoint icon, on a route planning map. In an embodiment the display device 272 can be a browser-based application to enable a user to check the expected range of their vehicle based on the current charge state of the battery. For example, an employee who uses an electrical vehicle to commute to and from work could plug their vehicle into an outlet when they arrived at work. In the afternoon, the employee could log onto a website (or access the TC 20 via other communications technologies described herein) to obtain a near real-time estimate of the expected range of their vehicle based on the charge information received by the TC 20 during an ongoing CI.

In an embodiment, the performance data mined from the accumulative database 276 can be provided on a user's statement 240. This information could alert the user of potential performance issues with their vehicle and could facilitate preventative maintenance before the vehicle suffers a more serious malfunction or breakdown. For example, a user could receive periodic email messages to indicate that the accumulative data collected from vehicles similar to theirs (i.e., make/model/year/battery-model/technology/battery-state (30% full)) shows that approximately two hours of charging at a particular location will extend the range by a number of miles according to the current driving conditions (i.e., day/night, summer/winter, highway/town). Other messages received from the TC 20 could indicate that the accumulative data collected for vehicles similar to yours (e.g., make/model/year/battery-model/technology/battery-state (30% full)) shows that the user's battery is functioning at 75% of its potential.

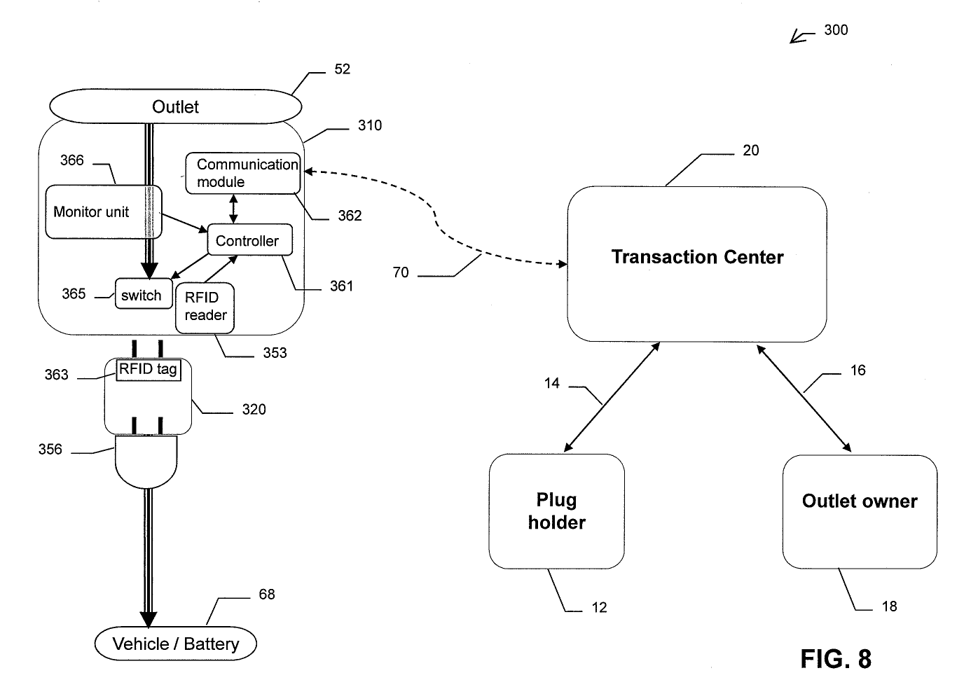

Referring to FIG. 8, with further reference to FIG. 2, an electrical power metering and billing network 300 including an outlet configured to communicate with a transaction center 20 is shown. The outlet 52 is operably connected to an enabling device 310. The outlet 52 and the enabling device 310 can be manufactured as a single unit, or the enabling device 310 can be mounted, or otherwise rigidly attached to, an existing outlet 52. The enabling device 310 can include a controller 361, a communication module 362, a switch 365, a metering unit 366, and an RFID reader 353. The controller 361 can include a processor and memory (not shown) and can be specifically programmed to enable communication with the Transaction Center 20. In operation, the enabling device 310 can detect and identify a user's Plug Key 320. The Plug Key 320 can include an RFID tag 363, or other unique ID mechanism, to identify the Plug Key 320 with a user account. In an embodiment, the identification of the Plug Key 320 can be determined by the enabling device via a digital control signal on the power conductor. The Plug Key 320 can be a hand-held device which can be detached from both the enabling device 310 and a vehicle plug 356. The enabling device 310 can be programmed to initiate and monitor a CI as described in FIG. 3.

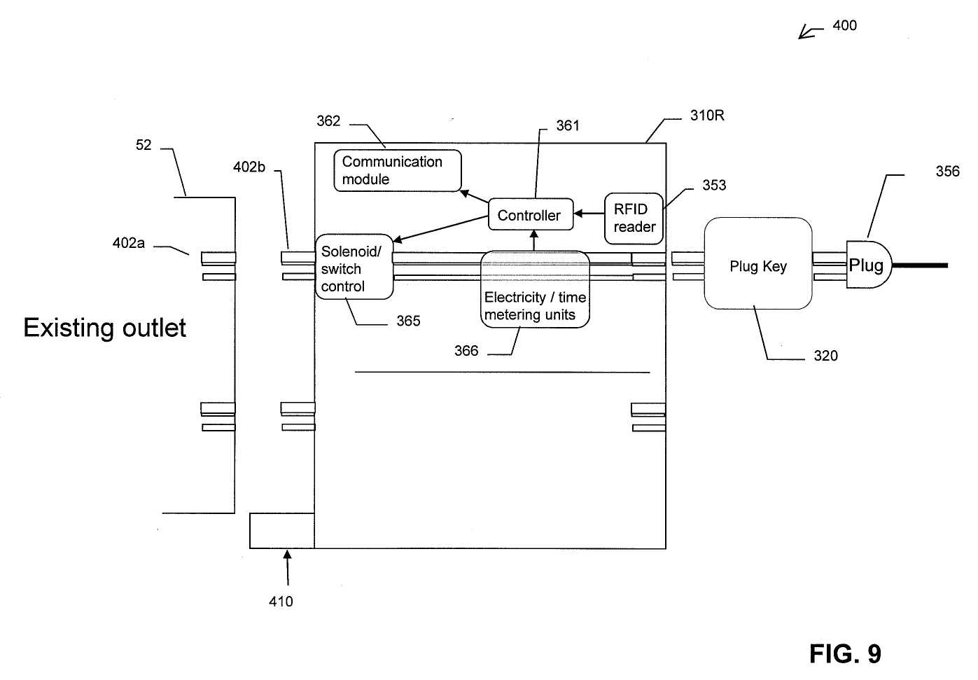

Referring to FIG. 9, with reference to FIG. 8, an outlet control retrofit device 400 is shown. The outlet device 310R can include a controller 361, a communication module 362, a switch 365, a metering unit 366, and an RFID reader 353 as previously described. The controller 361 includes memory and a processor programmed per the algorithms described in FIG. 3. The outlet device 310R is configured to mate with existing outlets (i.e., through male and female connections 402b, 402a) and includes a securing mechanism 410 to attach with outlet device 310R to an existing outlet 52. For example, the securing mechanism 410 can be a threaded bolt with a custom head, a locking bolt, a barbed fitting, or other fittings configured to restrict the disjoining of the outlet device 310R from the outlet 52. The outlet device 310R can include a manual “stop charging” actuator (not shown) which can be utilized when the user wants to end a charging instance manually. The actuator will open the switch 365 (i.e., stop the flow of electricity) and the controller 361 will execute the procedures indicated at stage 124 of FIG. 3.

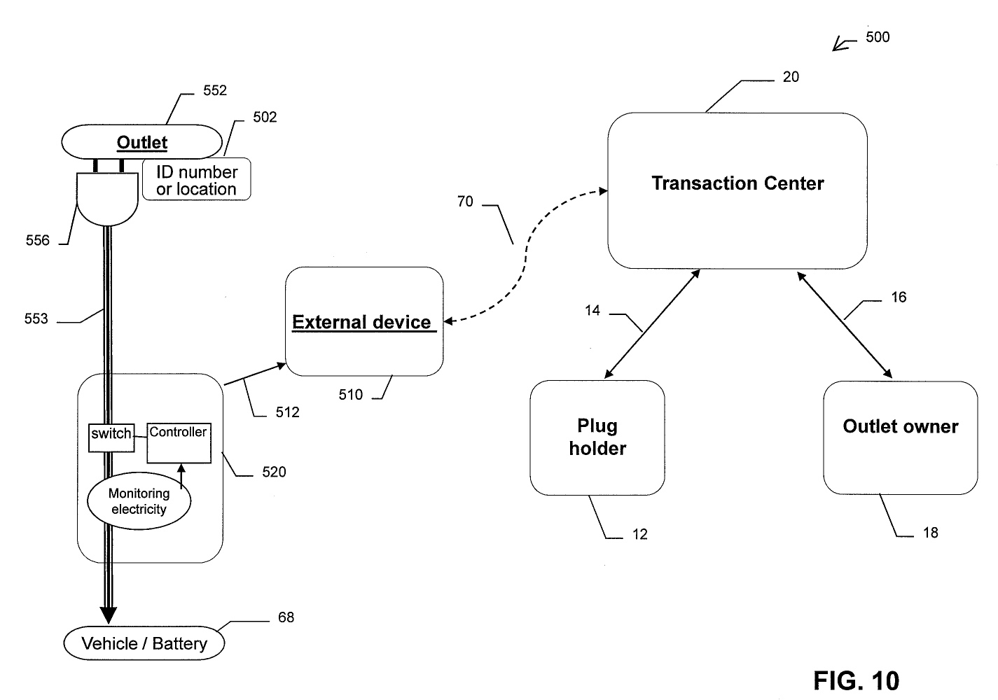

Referring to FIG. 10, an exemplary block diagram of an embodiment of an electrical power metering and billing network 500 including an external device configured to communicate with a transaction center is shown. The external device 510 can be a network connected device such as an iPhone®, or other programmable smart device configured to communicate over a wireless network. The network 500 includes an outlet 552 with an ID number or location information 502, an electrical monitoring device 520, an external device 510, a plug 556, and a power conduit 553. The monitoring device 520 is configured to measure the power transferred to the vehicle/battery 68. The monitoring device 520 can also communicate with the external device 510 via a communications link 512 (e.g., wired or wireless).

In operation, the external device 510 can receive outlet ID information 502 via a wireless link such as a WiFi hotspot. In an embodiment, the external device can determine a location based on GPS information. The determination of the outlet ID can be made locally (i.e., via a table stored on the device 510), or the location information can be sent to the TC 20 wherein an outlet, or list of outlets, can be returned to the device 510 from the TC. In an embodiment, a user can manually enter the location information 502 into the device 510. As an example, and not a limitation, an outlet ID number can be displayed on the outlet in a dynamic media such as an LCD display. This can allow an outlet owner to periodically change the ID numbers to help reduce fraud. In an embodiment, a change in the outlet ID number 502 can be initiated by the TC 20. For example, the outlet ID displays can be networked in a cluster, wherein the cluster can communicate with the TC. Allowing the TC 20 to change outlet IDs on a periodic basis (e.g., minutes, hours) can also assist in minimizing fraud.

The external device 510 is operably connected to the monitoring device 520, and can be configured to receive and store charging information such as voltage, current, and time. The device 510 can be configured to communicate with the TC 20 via a communications link 70. The external device 510 can be programmed to perform the stages identified in FIG. 3 and previously described herein. In an embodiment, the external device 510 can include a display and can be configured to display range information as depicted and described in FIG. 7.

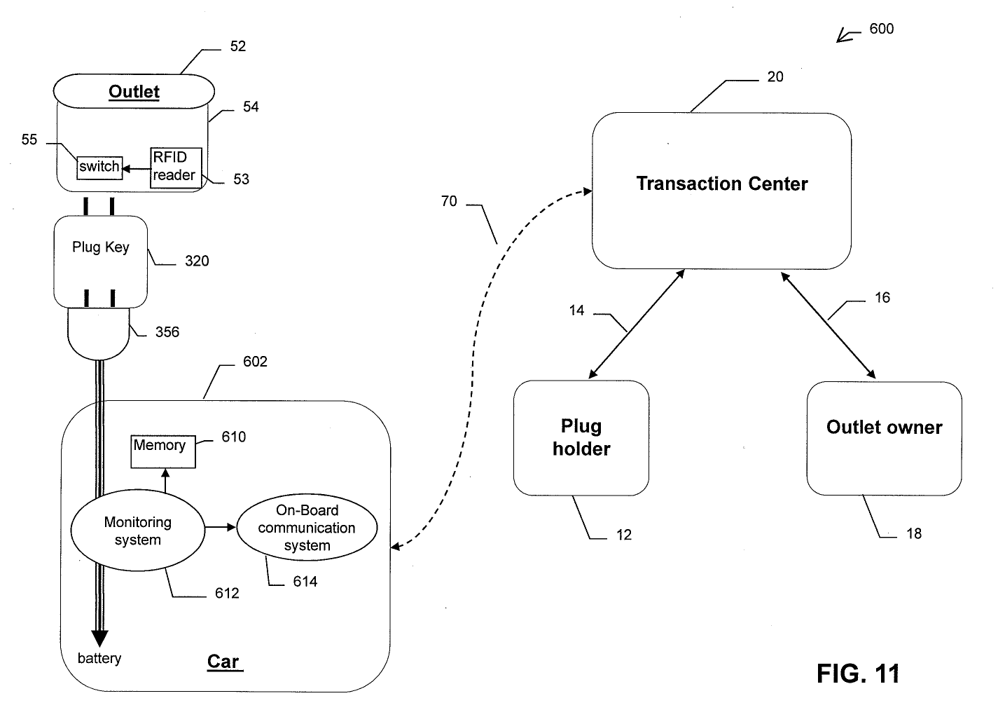

Referring to FIG. 11, a block diagram of an embodiment of the an electrical power metering and billing network 600 utilizing a plug key and an on-board communication system to communicate with a transaction center. The system includes a vehicle 602 equipped with programmable electrical monitoring system 612, a memory 610, and an on-board communications system 614. In operation, a user's Plug Key 320 identification and outlet ID information can be entered and stored in the memory 610. In an embodiment, the vehicle can include a GPS system and the corresponding location information can be stored in memory. The vehicle's electrical monitoring system 612 can include a computer configured to execute the instructions described in FIG. 3. The communication system 614 can establish a link 70 with the TC 20. Based on the sophistication of the vehicle's on-board computer system, the data display and communications embodiments described herein can be accessed and presented on the vehicle's display system. For example, the vehicle's range derived from the accumulative database 276 can be displayed while the vehicle is in motion. Potential locations for a charge, and the associated prices and promotional information, can also be displayed on a function of the vehicle's location.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

The transaction center 20 features and functions can be used to aggregate a cluster of vehicles in an area and to control the flow of electricity back to a source with the appropriate fund transfer.

The electrical power metering and billing network 10 is not limited to applications involving electric vehicles and can be used in a wide variety of applications which require electricity. In an embodiment, the network 10 can be used for powering laptop computers and other personal electrical devices in public areas such as airports and terminals, as well as on transportation vehicles (e.g., trains, planes, buses).

In an embodiment, a user can utilize the ICS, GPS, or an internet enabled device, to search for outlets based on location and/or rate information. A user can be empowered to find more efficient and cost effective charging options.

Further, while the description above refers to the invention, the description may include more than one invention.

What is claimed is:

1. A computer implemented method to facilitate the purchase of electricity between a static provider and a dynamic customer, comprising:
establishing a communications connection between an enabling device and a transaction center;
receiving information about a plug associated with the customer and an outlet associated with the provider;
utilizing a computer in the transaction center to calculate a cost of electricity based at least on the received plug and outlet information; and
sending the cost of electricity to the enabling device.

2. The computer implemented method of claim 1 further comprising:
connecting a customer's electrical load to a provider's electrical source, wherein the enabling device is configured to monitor electricity flowing from the source to the load;
calculating a cost of a charging instance based on the cost of electricity and information associated with the electricity flowing from the source to the load; and
displaying the cost of the charging instance on the enabling device.

3. The computer implemented method of claim 2 wherein the enabling device is configured to control and monitor the flow of electricity from the source to the load.

4. The computer implemented method of claim 1 further comprising:
connecting a customer's electrical load to a provider's electrical source, wherein the enabling device is configured to at least monitor the flow of electricity from the source to the load;
sending charging instance information to the transaction center;
storing the charging instance information on at least one data storage device;
utilizing at least one computer to calculate a cost associated with the charging instance based at least on the charging instance information and the received plug and outlet information;
notifying the customer and the provider of the costs associated with the charging instance; and
transferring funds based on the cost of the charging instances between accounts associated with the customer and the provider.

5. The computer implemented method of claim 4 wherein notifying is implemented via a member of a group of communications methods consisting of a letter, email message, SMS message, web services message and web portal update.

6. The computer implemented method of claim 1 wherein the information about the outlet is a geographic position.

7. The computer implemented method of claim 1 wherein the transaction center is configured to identify and aggregate electrical loads to control the flow of electricity from the loads to a source and to facilitate the fund transaction between accounts associated with the providers and the customers.

8. The computer implemented method of claim 1 further comprising storing information about the customer associated with the plug.

9. A system for determining and reconciling costs associated with charging an electric load, comprising:
at least one data storage device having an interface for communicating over a computer network, the data storage device including a data structure comprising:
a plug ID associated with the electric load;
an outlet ID associated with an electrical source;
a charging instance ID associated with a single charging instance;
at least one server computer having an interface for communicating over a computer network, wherein the server computer is programmed to:
communicate with the data storage device;
receive charging instance data comprising a plug ID and an outlet ID;
generate a charging instance ID;
store the charging instance ID, plug ID and outlet ID in the data storage device;
calculate a cost associated with the charging instance data; and
transmit the cost associated with the charging instance data over the computer network.

10. The system of claim 9 wherein the server computer is programmed to:
receive a request for a charging instance, wherein the request includes the plug ID;
verify the plug ID against at least one preexisting data table; and
send a charging instance approval code based on the verification.

11. The system of claim 9 wherein the server computer is programmed to:
create a billing statement for a plug holder based on the costs of each charging instance associated with the plug holder;
transmit the billing statement to a destination associated with the plug holder; and
transferring funds based on the costs associated with the charging instances from an account associated with the plug holder to at least one account associated with at least one Outlet ID.

12. The system of claim 9 wherein the server computer is programmed to:
create a usage statement for an outlet owner based on the costs of each charging instance associated with the outlet owner; and
transmit the usage statement to a destination associated with the outlet owner.

13. The system of claim 9 wherein the data storage device includes a data structure for electricity rate promotions data and the server computer is programmed to calculate the cost associated with the charging instance based on the electricity rate promotions data.

14. The system of claim 9 wherein the server computer is programmed to calculate an expected range of the electric vehicle based on charging instance data, and transmit the expected range over the network.

15. The system of claim 14 wherein the server computer is programmed to calculate the expected range of the electric vehicle based on a collection of charging instance data stored on the data storage device.

16. An apparatus to enable the purchase of electricity, comprising:
a communications module configured to transmit and receive data over a network;
an electrical monitoring module configured to measure the electrical current flowing from the outlet to a load;
an electrical switch;
a controller including a memory module and a processor programmed to:
transmit a charging instance request including an Outlet ID and a Plug ID;
receive a charging instance approval;
control the electrical switch to allow electricity to flow from the outlet to the load based on the charging instance approval;
periodically transmit charging instance information including electrical current measurement data;
terminate the charging instance; and
transmit a charging instance summary including the duration or amount of electricity transferred during the charging instance.

17. The apparatus of claim 16 wherein the charge instance approval includes charging parameters and the processor is programmed to control the charging instance based on the charging parameters.

18. The apparatus of claim 16 wherein the processor is programmed to:
detect a communication failure related to the periodically transmitted charging instance information;
store the charging instance information in the memory; and
subsequently transmit the charging instance information.

19. The apparatus of claim 16 further comprising a retrofit device configured to retrofit an existing electrical outlet to control the flow of electricity from the outlet to the electric load during a charging instance to prevent unauthorized electrical flow from existing outlet, the retrofit device further comprising a securing mechanism configured to restrict the disjoining of the apparatus from the outlet.

20. The apparatus of claim 19 further comprising a RFID reader operably connected to the controller and configured to detect the Plug ID of a plug key disposed within the operational range of the RFID reader.

21. The apparatus of claim 16 wherein at least one of the communications module, electrical monitor, the controller, the switch, and the RFID reader are disposed in separate enclosures.
